(19) United States
(12) Patent Application Publication
(10) Pub. No.: US 2016/0182594 A1
(43) Pub. Date: Jun. 23, 2016

(54) ADAPTIVE STREAMING

(71) Applicant: Cable Television Laboratories, Inc., Louisville, CO (US)

(72) Inventors: Gregory White, Arvada, CO (US); Robert Lund, Boulder, CO (US)

(21) Appl. No.: 14/975,734

(22) Filed: Dec. 19, 2015

Related U.S. Application Data
(60) Provisional application No. 62/094,479, filed on Dec. 19, 2014.

(51) Int. Cl. H04L 29/06; H04L 29/08

(52) U.S. Cl. CPC H04L 65/607; H04L 67/02

(57) ABSTRACT

Adaptively streaming media encoded at variable bit rates and/or optimizing the presentation thereof according perceivable capabilities of a client or other device interfacing the media with a user is contemplated. The adaptive streaming and media selection processes may be utilized with virtually any suitable mechanism for exchanging media, such as but not necessarily limited to optimizing usage of Dynamic Adaptive Streaming over HTTP (DASH) to manage network resources according to capabilities of user to perceive the corresponding media.

### CROSS-REFERENCE TO RELATED APPLICATIONS

This application claims the benefit of U.S. provisional Application No. 62/094,479 filed Dec. 19, 2014 the disclosure of which is incorporated in its entirety by reference herein.

### TECHNICAL FIELD

The present invention relates to adaptively streaming media encoded at variable bit rates and/or optimizing the presentation thereof according perceivable capabilities of a client or other device interfacing the media with a user, such as but not necessarily limited to optimizing Dynamic Adaptive Streaming over HTTP (DASH).

### BACKGROUND

Dynamic Adaptive Streaming over HTTP (DASH), such as that described in Part 1: Media presentation description and segment formats (ISO/IEC 23009-1, Second edition, 2014 May 15), the disclosure of which is hereby incorporated by reference in its entirety herein, relates to employing Hypertext Transfer Protocol (HTTP) to facilitate transferring media content from a server to a client. DASH specifies Extensible Markup Language (XML) and binary formats that enable delivery of media content from HTTP servers to HTTP clients and enable caching of content by HTTP caches, such as in accordance with messaging and other processes described in Internet engineering task force (IETF) request for comment (RFC) 2616, the disclosure of which is hereby incorporated by reference in its entirety herein. DASH, as noted in the above identified specification, is intended to support a media-streaming model for delivery of media content whereby clients may request data using the HTTP protocol from web servers, including those lacking DASH-specific capabilities. While the present invention is not necessary limited to DASH, DASH is representative of one distribution model having processes for selecting, encoding and transmitting media content lacking the optimization contemplated by the present invention.

### BRIEF DESCRIPTION OF THE DRAWINGS

FIG. 1 illustrates a system for adaptively facilitating access to a media within a dwelling in accordance with one non-limiting aspect of the present invention.

FIG. 2 illustrates a flowchart of a method for optimizing media streaming in accordance with one non-limiting aspect of the present invention.

FIG. 3 illustrates a chart-based presentation of metadata in accordance with one non-limiting aspect of the present invention.

FIG. 4 illustrates an MPD-based presentation of metadata in accordance with one non-limiting aspect of the present invention.

FIG. 5 illustrates a perceived quality graph in accordance with one non-limiting aspect of the present invention.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

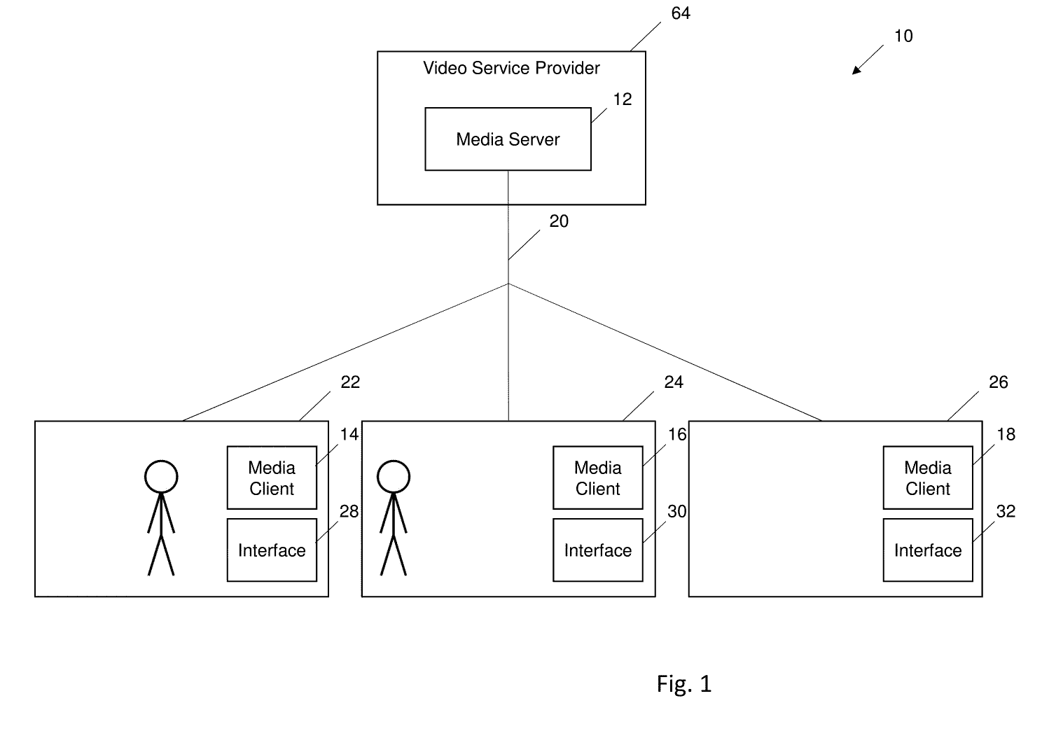

FIG. 1 illustrates a system 10 for adaptively streaming media in accordance with one non-limiting aspect of the present invention. The system 10 may be configured to facilitate optimizing media streaming from a media server 12 to a plurality of media clients 14, 16, 18 according to network resources available over a shared medium 20 and/or information, characteristics, metrics and other data available for occupant(s) present within one or more zones 22, 24, 26 associated with a corresponding media interface 28, 30, 32. The zones 22, 24, 26 illustrate one of many possible environments where a broad range of media, services, etc. may be made available to a particular location and then subsequently optimized depending on occupant capability to audibly, visually and/or haptically interface with the media. The system 10 may operate in accordance with the presence detection processes described in U.S. patent application Ser. No. 13/792,089, the disclosure of which is hereby incorporated by reference in its entirety herein, to facilitate assessing user presence and characteristics and is predominately described for exemplary, non-limiting purposes with respect to a server-client configuration operable in accordance with DASH or other suitable media transmission standards.

The shared medium 20 may be any network sufficient to facilitate exchanging Internet protocol (IP) layer messaging or other suitable signaling between the media server 12 and the media clients 14, 16, 18, such as to facilitate the contemplated media streaming and/or additional services available from a media service provider 36. The shared medium 20 may be configured as an IP-based network having capabilities sufficient to facilitate wired and/or wireless IP-layer message exchange according to HTTP whereby bandwidth is commonly shared between each media client 14, 16, 18 resulting in bandwidth consumed by one media client 14, 16, 18 diminishing bandwidth available to the other media clients 14, 16, 18. The available bandwidth or bit rate may vary statically or dynamically depending on network congestion, quality of service (QOS), subscription rights, entitlements or any number of other variables, including the bit rate varying for upstream and downstream communications. The bandwidth sharing or co-dependency of the media clients 14, 16, 18 may dynamically affect the network resources, network congestion levels and otherwise influence bandwidth or bit rates available to facilitate streaming media. The present invention fully contemplates facilitating media streaming using non-shared resources and describes the shared medium 20 merely for describing a scenario where media selection may be influenced depending on dynamically changing resources.

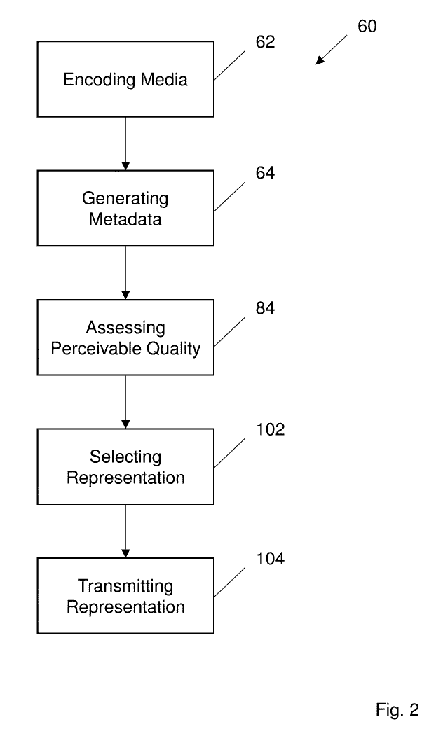

FIG. 2 illustrates a flowchart 60 of a method for optimizing media streaming as a function of bit rate limitations and/or other capabilities of the media clients 14, 16, 18 in accordance with one non-limiting aspect of the present invention. The processes and other operations associated with the method may be facilitated with one or more of the above-described devices having a plurality of non-transitory instructions stored on a computer-readable medium, which when executed with a processor associated therewith, are sufficient to facilitate the processes necessary to optimize media streaming in the contemplated manner. The media may be any type of content suitable for transmission in accordance with the present invention, such as video, audio and the like, and is predominately described for exemplary non-limiting purposes as being video. The video may correspond with a television program, a movie, a personal recording, a videoconference or other arrangement having a plurality of images and/or audio to be presented in a particular sequence. One non-limiting aspect of the present invention contemplates the video being transmitted to the media server 12 from a studio or other originator as a plurality of video frames or Moving Pictures Experts Group (MPEG) frames whereupon the media server encodes and optimizes the video for subsequent transmission to the media clients, which optionally may occur based on information collected with the above-described presence detection and/or independently thereof in any suitable server-client setting.

Block 62 relates to the media server 12 or other device associated therewith encoding the received video. The encoding may generally correspond with an encoder or other application compressing or processing the received video frames for transport, such as with the use of mechanisms and capabilities understood by one having ordinary skill in the art operating to facilitate the optimizations contemplated herein. The encoding may correspond with the encoding described in DASH whereby a particular video may be encoded to create a number of representations with the set of frames comprising each representation being variably compressed in order to maintain a constant bit rate throughout an entirety of the corresponding representation. The encoding may alternatively correspond with the similar encoding described in DASH whereby the set of frames comprising each representation being variably compressed in order to maintain a constant bit rate for the majority of the duration of the representation, but allowing the bit rate to decrease for a certain minority of the duration of the representation, which may be referred to as a constrained variable bit rate approach. In either alternative, each such representation may thereby have some frames encoded at differing or varying resolution or quality in order for an entirety of the corresponding representation to be streamed at essentially a constant bit rate from start to finish. This type of constant bit rate encoding generally corresponds with the representations having a greater average bit rate providing higher quality video than the representations encoded at a lower average bit rate. The greater bit rates enable more data (bits) to be used in representing the original video so as to enable the video to be reproduced following encoding at a greater resolution or with other quality characteristics better than the lower bit rate encodings.

The use of such constant bit rate encodings may be useful when available bandwidth or other network restrictions or capabilities are unchanging during the duration of the video playback, and are a predominant factor in deciding which one of the representations is desired for access as the essentially unwavering bit rate enables media clients to simply select the representation having the maximum supportable bit rate. The use of such constant bit rate encodings may also be beneficial when generating metadata or other information used to facilitate the selection thereof as a single bit rate attribute can be assigned for an entirety of each representation. DASH, for example, utilizes a media presentation descriptor (MPD) to provide information associated with available representations within the MPD where a single bit rate or bandwidth attribute is assigned to each available representation, i.e., the number of bit rate or bandwidth attributes equals the number of representations. One non-limiting aspect of the present invention contemplates optimizing video streaming by similarly encoding the video into multiple representations but with each or some representations having a constant quality and variable bit rate. The constant quality and variable bit rate may generally correspond with each frame or underlying portion of the media being encoded at bit rates necessary to maintain a desired spatial and/or temporal resolution and/or a desired distortion level throughout an entirety of the corresponding representation.

The constant quality encoding may result in the bit rates for a particular representation varying throughout the corresponding representation depending on the complexity of the corresponding frame or portion of video. While constant bit rate encodings may have some bit rate variations due to encoding tolerances or other inherent variables, those bit rate variations may be centered at a mean or average bit rate whereby the quality of the attendant portion of video is adjusted to maintain the constant bit rate. The constant quality encodings, in contrast, may be centered at a mean of average quality with the bit rate being unconstrained to any mean or average value whereby the bit rate of the attendant portion of video is adjusted as necessary to maintain the constant quality. The metric or measure of the constant quality encoding process may be based on spatial and/or temporal resolution or other quality metrics or levels such as the quantization parameter or quantizer coefficients. The maintenance of a constant quality may result in more complex video frames requiring a greater bit rate than less complex video frames as more bits may be required in order to represent the entirety of the underlying video at the same spatial and/or temporal resolution. The constant quality encoding process may be characterized with the bit rate continuously varying to maintain a constant quality whereas the constant bit rate encoding process may be characterized with the quality continuously varying to maintain a constant bit rate.

Block 64 relates to generating metadata sufficient to facilitate representing the encoding performed for any number of videos, particularly when undertaken according to the described constant bit rate and/or constant quality processes. The metadata may match or partially corresponding with the DASH MPD described above or virtually any file, document or other suitable construct having data or other syntax suitable for conveying information to the media clients 14, 16, 18 necessary for parsing and accessing media encodings made available for transport from the media server 12. One non-limiting aspect of the present invention contemplates use of the DASH MPD when representing video encoded according to the constant bit rate process and deviating from the DASH MPD when representing video encoded according to the constant quality process. The constant quality MPD or other metadata construct for the constant quality encodings may deviate insofar as including additional attributes, values, etc. sufficient to represent characteristics associated with the corresponding constant quality encoding process. Additional or different metadata may be generated to specify quality metrics for each representation, such as but not necessary limited to the attendant spatial and/or temporal resolution and/or a subjective quality index, and/or to specify bit rate variations for each representation, such as by including a number of attributes sufficient to at least indicate each significant bit rate variation (e.g., each bit rate change above a selectable threshold).

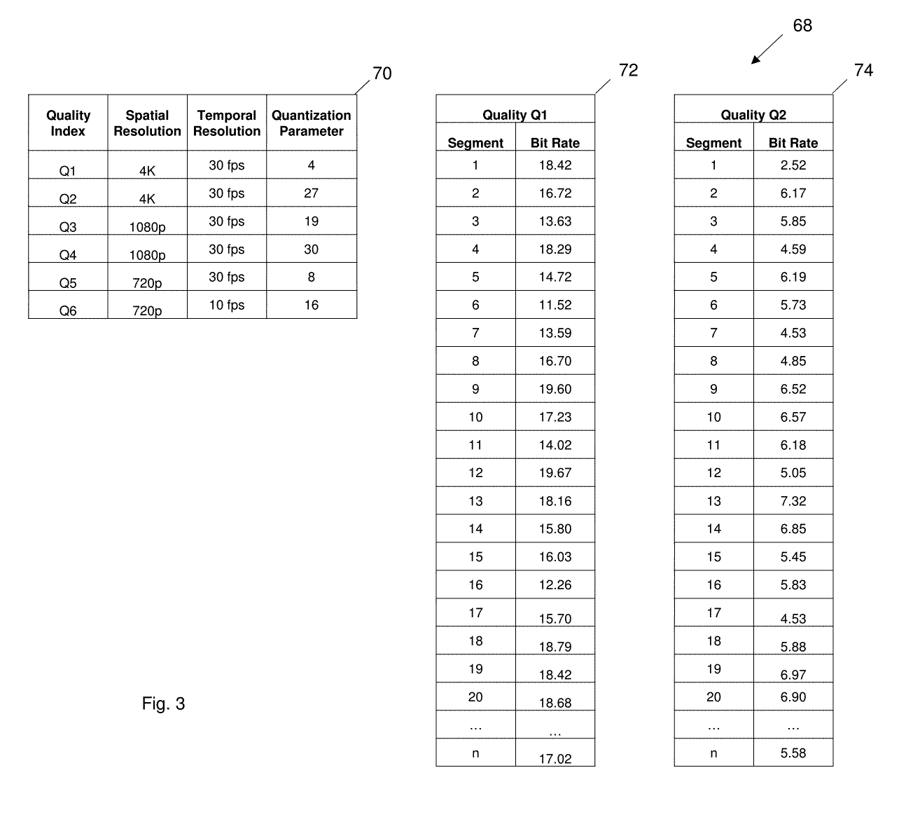

FIG. 3 illustrates a chart-based presentation 68 of the metadata in accordance with one non-limiting aspect of the present invention. A first chart 70 crosses-references a quality index according to associated spatial resolution, temporal resolution and/or quantization levels (parameter), which are shown to correspond with pairings of the more common spatial resolutions of 4K, 1080p and 720p and temporal resolutions of 30 frames per second (fps) and 10 fps. The quality index may be a value or attribute sufficient to represent virtually any type or combination of quality metric(s) utilized for an associated encoding, optionally including a single resolution instead of the illustrated resolution pairings and/or other resolutions such as a higher resolution than 4k, 1080i, 480p/i, etc. and/or greater/lower temporal resolutions. A second chart 72 represents bit rate variations for a first representation generated by encoding a video at a constant quality commensurate with Q1 whereby each bit rate value is cross-referenced with a corresponding segment of the first representation to reflect the encoding thereof. A third chart 74 represents bit rate variations for a second representation generated by encoding the same video at a constant quality commensurate with Q2 whereby each bit rate value is similarly cross-referenced with a corresponding segment of the first representation to reflect the encoding thereof.

The first, second and third charts 70, 72, 74 or charts similarly prepared for other media representations available from the server 12 on-demand may be provided to the media clients 14, 16, 18 in advance of access, optionally with additional information regarding the available media, messaging, protocols, etc., so as to enable the media clients 14, 16, 18 to select a suitable representation for streaming, including dynamically and/or continuously changing the selection as network resources vary due to additional media clients 14, 16, 18 requesting and/or ceasing streaming or other operations diminishing or increasing available bandwidth. Similar information to that provided in charts 72, 74 may be generated for live or real-time media using estimates or other forecasts, including but not necessarily limited to statistical characterizations, of expected segment-based bit rate variations when the associated media is contemplated for constant quality encoding (estimates would be unnecessary for constant bit rate encodings as the media clients 14, 16, 18 would know the intended bit rate throughout its entirety). Live or real-time media related charts may optionally span less an entirety of the associated media and instead include an initial segment-level forecast or estimate with subsequent charts or updates being provided as the live media progresses.

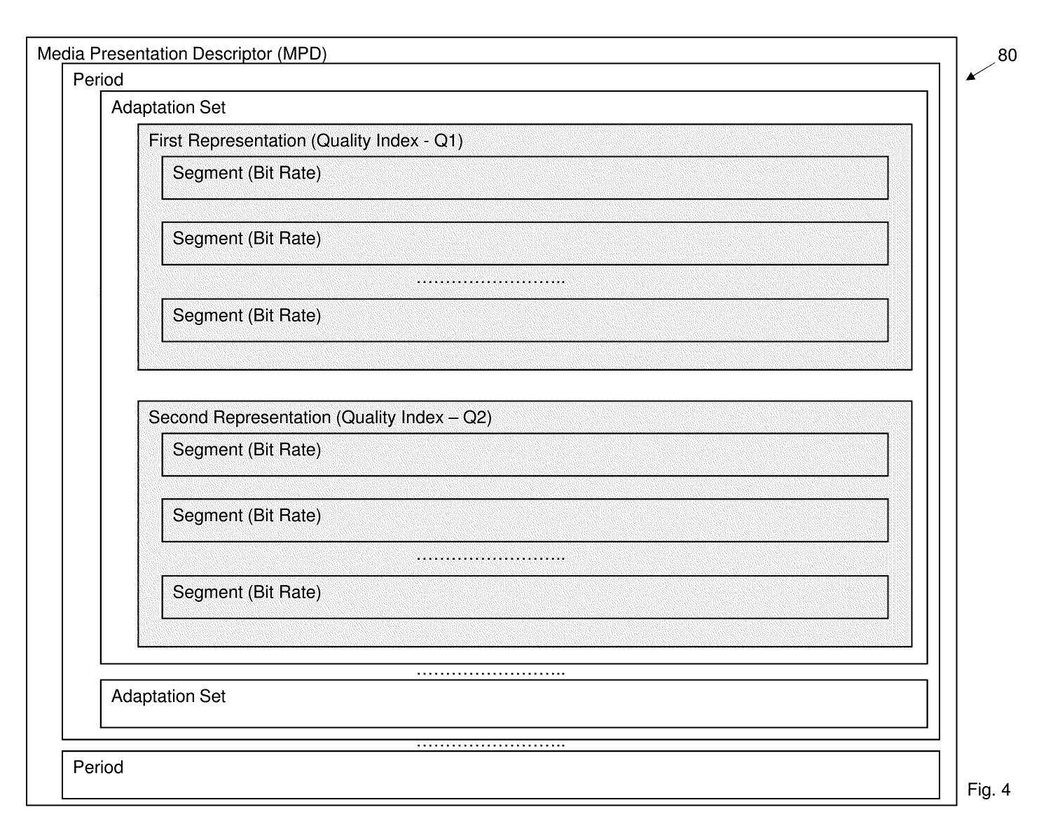

FIG. 4 illustrates an MPD-based presentation 80 of the metadata in accordance with one non-limiting aspect of the present invention. The MPD 80 may be similar to that described within DASH in so far as including universal resource locators (URLs), XML schema and other variables, attributes, etc. used to identify available media and facilitate its delivery to a requesting media client 14, 16, 18 using HTTP interactions or other suitable processes. The media server 12 may be configured to generate an MPD 80 for each piece of available media or media presentation, e.g., the MPD 80 may be generated for each television program, movie, video or other content available to the media clients. The MPD 80 may describe a sequence of periods in time comprising a particular sequence of media comprising a media presentation. A period may be used to represent a media content period during which a constant set of encoded versions of the media is available, i.e. the set of available languages, captions, subtitles etc. may not not change during the corresponding period. Within a period, material may be arranged into adaptation sets sufficient to represents a set of interchangeable encoded versions of one or several media content components.

There may be one adaptation set for the main video component and a separate one or more for a main audio component or other material available like captions or audio descriptions. The illustrated MPD 80 omits the additional, non-video components for exemplary purposes in order to illustrate the contemplated optimization of the MPD 80 to support communicating information associated with constant quality encodings. Each adaptation set contains a set of representations describing a deliverable encoded version of one or several media content components, which is illustrated for exemplary purposes to correspond with the above-described first and second representations respectively encoded at a constant quality commensurate with Q1 and Q2. A representation may include one or more media streams (one for each media content component in the multiplex) and be sufficient to render the contained media content components. By collecting different representations in one adaptation set, the media server may express the corresponding representations as being equivalent content.

The media clients 14, 16, 18 may dynamically switch from representation to representation within an adaptation set in order to adapt to network conditions or other factors. Switching refers to the presentation of decoded data up to a certain time t, and presentation of decoded data of another representation from time t onwards. If representations are included in one adaptation set, and the media client 14, 16, 18 switches properly, the media presentation may be expected to be perceived seamless across the switch. Media clients 14, 16, 18 may ignore representations that rely on codecs or other rendering technologies they do not support or that are otherwise unsuitable. Within a representation, the media may be divided in time into the segments illustrated in FIG. 3 for proper accessibility and delivery. In order to access a segment, a URL may be provided for each segment operable to facilitate corresponding HTTP requests. A segment may be the smallest unit of data that can be retrieved and independently decoded by the media client 14, 16, 18 with a single HTTP request and/or a byte range with the URL indicating the segment is contained in the provided byte range of some larger resource. Segments may be each assigned a duration corresponding with presentation of the media contained in the segment when played at normal speed. All Segments in a representation may have the same or roughly similar duration with the last segment optionally differing.

One non-limiting aspect of the present invention contemplates segments in each representation representing the same duration or portion of the media content such that each segment matches with one segment in another representation for exemplary purpose as segment duration may differ from representation to representation. The segments may generally relate to intervals or other identifiable portions of the corresponding representation amenable to conveying the corresponding bit rate variations necessary to maintain a constant quality throughout. The bit rate variations are shown with respect to exemplary numerical values demarcating an average or other summation of the bit rate utilized for encoding the corresponding segment. This segment-level granularity may be preferred over identifying a bit rate value for each encoded frame in order to limit the number of bit rate values included within the metadata to represent the available encodings, particularly since the client is typically only able to switch representations on a segment boundary.

The MPD 80 may include a quality index attribute within an attribute table or other construct sufficient to convey a constant quality encoding level for the corresponding representation. The client may analyze the constant quality index attributes as part of its decision making process when determining a suitable representation for streaming. The quality index attributes may be included in the MPD 80 to differentiate the representations being encoded at a constant quality from those being encoded at a constant bit rate when the MPD 80 also includes information for available representations encoded at a constant bit rate (not shown). The number of quality index attributes included within the MPD 80 may equal the number of representations encoded at a constant quality and may be communicated along with the first chart 70 or other information sufficient to enable the client to differentiate parameters associated with the corresponding quality index attribute, e.g., 4k, 30 fps, etc. The MPD 80 may also include bandwidth or bit rate attributes within the attribute table or other construct to identify the bit rate of an associated segment. The number of bandwidth or bit rate attributes included with the MPD 80 may equal the number of segments so that the media client 14, 16, 18 can assess whether network resources are likely to support the bit rates needed or estimated for an entirety of the corresponding representation.

Returning to FIG. 2, once the metadata associated with the charts 70, 72, 74 and/or MPD 80 are generated, Block 84 relates to assessing perceivable quality capability for a media client 14, 16, 18 desiring streaming. The perceivable quality may be a representation of the media client's 14, 16, 18 capability of the interface 28, 30, 32 to interface the corresponding media with a user or other device associated with the user. One non-limiting aspect of the present invention contemplates the media client interfacing the media when formatted as a video with a television or other suitable display. The perceivable quality assessment in such a scenario may correspond with the media server and/or the media client determining capabilities of the interface with respect to the quality levels illustrated in the first chart 70, i.e., whether the television/display can support 4k, 1080p, 30 fps, 10 fps, etc. In addition to the interface capabilities, the perceivable quality assessment may also include analysis of the viewer or other user with respect to the interface. This assessment may include detecting a presence of a particular user and their individual ability to perceive the media, such as their distance from the television/display, capability to differentiate colors, age, personal preferences, habits or other characteristics indicating their ability to appreciate certain quality levels. This assessment may additionally include detecting the presence of multiple users and their individual abilities to perceive the media, and forming a single assessment of perceivable quality that is representative in some way of the multiple users.

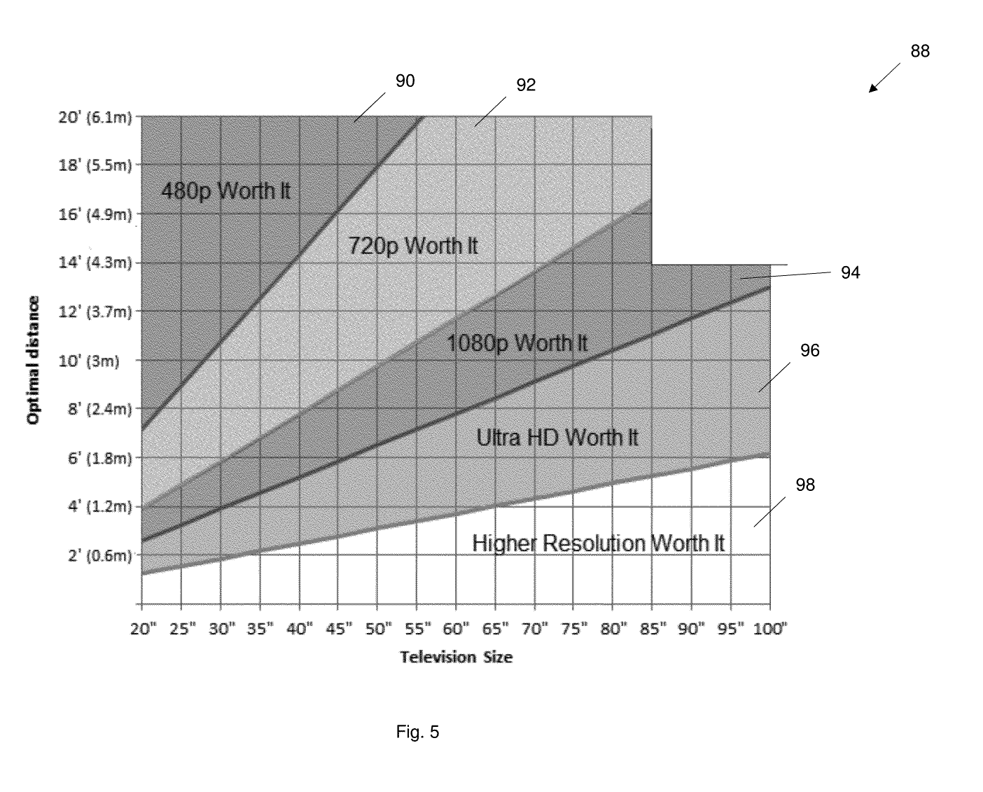

FIG. 5 illustrates a perceived quality graph 88 in accordance with one non-limiting aspect of the present invention. The graph 88 illustrates a perceived quality index or value for a typical viewer according to a display/television size and an optimal distance. The graph 88 includes a plurality of zones 90, 92, 94, 96, 98 intended to reflect a maximum spatial resolution a viewer is likely to appreciate or perceive based on the viewer's distance from a particularly sized display. The perceived quality index is illustrated as being related to the quality indexes included in the first chart 70 in order to relate the constant quality encodings to the perceivable capabilities of the viewer. The plurality of zones 90, 92, 94, 96, 98 are illustrated for exemplary purposes with respect to 480p, 720p, 1080p, UltraHD (4K) and a higher resolution to signify viewing distance and display size demarcations where the corresponding quality level may represent a maximum spatial resolution likely to be perceptible to the associated viewer, which may be characterized as being proportion to capability=display size/viewing distance. The graph is merely exemplary and omits the fps quality level variable and quantizer parameter variable in order to simplify the presentation as any number of quality level variables may be additionally included to facilitate determining an optimal one of the encodings for the perception capabilities of the viewer.

The perceivable quality assessment may also include relating spatial and/or temporal resolution or other encoding specifics to additional characteristics or capabilities of the user. One example may be associating a lower optimal resolution for users lacking sufficient eyesight or indicating a preference for lower resolution streaming, e.g., some users may desire or prefer lower resolution streaming in order to minimize consumption of network resources. As shown in the exemplary graph, various examples are available for assessing optimal viewing distance as function of television size and resolution. With respect to the distance/perception type of assessment, one approach may be utilize a relationship like that depicted in the graph to represent a resolvable spatial resolution as function of perception for the human eye at various distances. Based on this, a user with a 60″ 4k display could be downgraded to 1080p content (without them perceiving a difference) if the system detects that there are no viewers closer than 8′ to the display.

As discussed previously, the perceivable quality assessment may also account for compression effects beyond just encoded spatial and/or temporal resolution. For example, an UltraHD content source could be minimally compressed (e.g. with a low quantizer parameter) at 50 Mbps, in which case the graph may be an accurate representation of perceivable capabilities, however, the graph 88 may also instead represent UltraHD to be heavily compressed down to 10 Mbps in which case it might be more like 1080p quality. A user with the 60″ 4k display might stream a 4k encoding but it might be delivered at 50 Mbps if the closest viewer is less than 8′ away, 30 Mbps if they are 8′-10′ away, 20 Mbps if they are 10′-15′ away, and 10 Mbps if they are farther than 15′ away. The exact relationship between bit rate and effective or optimal resolution may depend on the encoder and on the content, optionally with each encoding being analyzed by the encoder to produce a suitable quality index for representing this effective resolution that is then used by a quality decision function or perceivable assessment process to determine a suitable representation for streaming. Quality Index could be directly represented as an effective vertical resolution (720, 1080, 2160, or any value in between) so that the decision function could just use the simple relationship depicted by the graph 88.

The perceivable quality assessment of Block 84 may include any number of assessments based on user presence, distance, capabilities, characteristics as well as quality levels, variables and other information associated with certain encodings and capabilities for transmitting the encodings. Block 102 relates to processing the related information and selecting a representation for presentation. The selection process may include initially eliminating the representations associated with quality levels exceeding those likely to be perceivable for the viewer, i.e., eliminating the quality levels exceeding those included in the graph 88 for a current viewing distance and display size associated with the viewer. The selection process may then include assessing bit rate variances for each remaining representation to determine whether network resources, bandwidth restrictions or other limitations are likely to influence an ability of the media client to support streaming an entirety of the corresponding representations. The representations likely to be perceivable but having one or more segment bit rates exceeding that likely to be supportable may be eliminated from the selection process such that the highest-quality or best representation remaining thereafter may be selected for presentation and/or a switch to another representation may be scheduled for the segments having unsupportable bit rates.

Block 104 relates to the media client transmitting an HTTP get request or other suitable inquiry to a URL or other address associated with the selected representation and/or the attendant segments to initiate streaming. While the streaming is predominately described with respect to HTTP protocols and communications over the Internet, the streaming or other signaling may be undertaking using non-HTTP processes without deviating from the scope and contemplation of the present invention. The transmitting process and/or the selection process may be continuously assessed to adjust for network congestion or other transmission variables such that representations may be switched as a function thereof. One non-limiting aspect of the present invention contemplates continuously monitoring a distance of the viewer to a television display when streaming video, such as using the above identified presence detection capabilities, and/or through other mechanisms so as to facilitate adjusting access representations depending on changes in user distance. Optionally, a distance sensor in the form of a scanning device, optical or signal sensor or other device may be included on or associated with the media clients 14, 16, 18 to sense viewer distance.

FIG. 1 illustrates an exemplary scenario where a user in the first zone 22 is positioned closer to the first interface 28 than a user within the second zone 24 is to the second interface 30 (the third zone 26 illustrates no user being within range of the interface 32). Assuming the first and second interfaces 28, 30 are the same sized television or otherwise have the same interface capabilities, the perceivable quality index of the user in the first zone 22 may be greater than that of the user within the second zone 24 due to being in closer proximity. The present invention predominately describes the perceivable quality index generally increasing as the user approaches or becomes closer to one of the interfaces 28, 30, 32 for exemplary non-limiting purposes based on an assumption that closeness improves perception. The interfaces 28, 30, 32 may be configured to facilitate interfacing other types of media where the perceivable quality may have an inverse relationship with proximity, e.g., perceivable quality may increase as distance increases, whereby the operations and processes contemplated herein may be adapted in order to optimize streaming and selection of the associated media accordingly.

The distance sensor may optionally be integrated with the presence detection capabilities to differentiate between viewers when multiple viewers are within a room and/or a viewing distance of the display for purposes of controlling the viewing distance measurement. The presence detection system may also be beneficial in assessing whether viewers are transient or otherwise not likely to be viewing the representation, e.g., the distance measurement may be based on a static viewer (e.g., station for a predetermined period of time) as opposed to another occupant traveling through the corresponding room or otherwise engaging in activities, such as with a tablet or second screen device, indicating a lack of awareness or interest in the streamed media. Once the media is transmitted in Block 104, and depending on whether the associated media client 14, 16, 18 is in possession of a full set of bit rate values or is periodically receiving bit rate updates thereafter, the media client 14, 16, 18 may continually evaluate during playback the recent history of actual received bit rates (i.e. the segment size divided by the segment download time), the amount of buffered video, the list of bit rates for future segments (weighing the near future segments more heavily) across the different representations, and the current perceivable quality index of the user to determine whether it should continue with the representation that it is currently downloading or switch to a different representation more appropriate for given network conditions and/or movement of the user.

As supported above, one non-limiting aspect of the present invention contemplates a display fitted with a viewer presence and viewer distance estimation sensor (e.g. Kinect or Primesense) that provides an input to an IP-STB or smart TV in order to affect the bitrate or quality selection algorithm in an adaptive bit rate system. Viewers' distances to the display, as well as information on the display itself (size, native resolution, etc) may be used to calculate the maximum video quality that can be perceived by the viewers. This information may be used in the adaptive bit rate selection algorithm to select an appropriate stream that provides the maximum perceivable quality at the minimum bit rate, thereby jointly maximizing perceptual video quality across a set of competing viewers that share a bottleneck network link and freeing capacity for other services. The integration of presence detection and other viewer characteristics with the contemplated constant quality media encoding and optimal perception characteristics allows the present invention to facilitate a streaming experience where media may be delivered at the lowest quality necessary to meet selectable perception levels. Such a capability may be particularly beneficial over constant bit rate encoding processes where the media client simply selects the highest quality level supportable giving associated bandwidth or bit rate capabilities regardless of whether the viewer can actually perceive the corresponding quality level. The present invention eliminates unnecessary inefficiencies and consumption of network resources without negatively or unduly influencing the viewer experience when network resources support a higher quality video than the user is able to perceive.

As a coarse example, when it is detected that viewers are not close enough to the display to perceive the difference in quality between 4k resolution and 1080p, the system would limit its choices of streams to those with 1080p resolution and below. In general, the algorithm would not be constrained to resolution selection, but would more optimally use a video quality metric (such as PSNR or another perceptual evaluation of video quality), and a model of display-mediated human visual acuity. In implementation, this system could be as simple as an effective spatial resolution score (scalar value) that accompanies each stream choice in the ABR manifest. The IP-STB player then simply uses the display size (and resolution) along with the distance to the closest viewer to calculate the maximum perceivable spatial resolution for that viewer, and compares that to the scores accompanying the stream choices.

Access Network capacity cost is an important factor that reduces the attractiveness of IPTV solution. One aspect of the present invention contemplates an adaptive bir rate (ABR) video system that maximizes joint video quality across a set of users that share a bottleneck link. The variant streams may be efficiently encoded using constant quality encoding (VBR) or near-constant quality encoding (constrained VBR) and are described to the player in terms of the statistical properties of the bit-rate. Clients may be presented with various encodings of a stream, and each client selects the “best” encoding that it can reliably receive. This selection criteria may be preferred oved a set of constant bit rate encodings (variable quality) at pre-configured bit rates where rate selection is performed by the client via use of historical estimates of available channel capacity. The various encodings contemplated by the present invention represent a set of constant quality encodings (variable bit rate) at pre-configured quality levels so as to enable the client to additionally use statistical information about the encodings of the stream (segment size distributions and autocorrelation) to select the encoding that provides maximum video quality while keeping the calculated probability of buffer under-run below an established threshold. As a result, individual clients that share a bottleneck link (e.g. cable serving group) achieve better QoE (higher and more constant video quality). This technique would be useful for any networked video distribution system. It becomes much more feasible when HTML5 Media Source Extensions are available in the player.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for adaptively facilitating access to a media component comprising:
encoding at a constant quality commensurate with a first quality index each of a plurality of segments forming the media component to create a corresponding plurality of first segments, including varying a bit rate associated with the encoding of at least two or more of the first segments; and
encoding at constant quality commensurate with a second quality index different than the first quality index each of the plurality of segments forming the media component to create a corresponding plurality of second segments, including varying a bit rate associated with the encoding of at least two or more of the second segments.

2. The method of claim 1 further comprising individually associating each of the first and second segments with a bandwidth attribute sufficient for independently representing the bit rate used to encode the corresponding segment and/or network bandwidth estimated for the streaming thereof.

3. The method of claim 2 further comprising cross-referencing within a table or a suitable construct each of the bandwidth attributes with the corresponding one of the first and second segments such that the quantity of bandwidth attributes listed in the table or construct at least equals the quantity of first and second segments.

4. The method of claim 1 further comprising selecting the first quality index to be greater than the second quality index such that the bit rate for each of the first segments matching with one of the second segments is greater than the matching one of the second segments.

5. The method of claim 1 further comprising selecting one of the first and second segments for Hypertext Transfer Protocol (HTTP) streaming to the client according to a perceived quality index representing a perceivable quality for a viewer viewing the media component through the client.

6. The method of claim 5 further comprising:
determining the perceived quality index to correspond with the first segments in the event the viewer is within a first distance range to the client when desiring to view the media component; and
determining the perceived quality index to correspond with the second segments in the event the viewer is within a second distance range to the client when desiring to view the media component, the second distance range being outside of the first distance range.

7. The method of claim 5 further comprising determining the perceived quality index as a function of a viewing distance and a display size, the viewing distance representing a distance of the viewer from a display of the client and the display size representing a viewable size of the display.

8. The method of claim 7 further comprising determining the perceived quality index to be greater for the same display size when the distance is shorter than when the distance is longer.

9. A non-transitory computer-readable medium having a plurality of non-transitory instructions, which when executed with a processor of an encoder, are sufficient for adaptively facilitating access to a media component, the non-transitory instructions being sufficient for:
encoding a plurality of segments representing the media component into a first representation having a constant quality commensurate with a first value, including individually varying a bit rate used for encoding each of the plurality of segments according to a complexity of the corresponding segment so as to maintain the constant quality at the first value for an entirety of the first representation, the complexity for at least two of the plurality of segments varying sufficiently for the first representation to require encoding at at least two different bit rates; and
encoding the plurality of segments representing the media component into a second representation having the constant quality commensurate with a second value, including individually varying the bit rate used for encoding each of the plurality of segments according to a complexity of the corresponding segment so as to maintain the constant quality at the second value for an entirety of the second representation, the complexity for at least two of the plurality of segments varying sufficiently for the second representation to require encoding at at least two different bit rates, the first and second values differing sufficiently such that the bit rates for matching segments included within both of the first and second representation proportionally differ.

10. The non-transitory computer-readable medium of claim 9 further comprising non-transitory instructions sufficient for encoding the plurality of segments, at least other than a last segment of the plurality of segments, to have a duration of approximately equal length and such that each of the plurality of segments within the first representation match with one of the plurality of segments included within the second representation.

11. The non-transitory computer-readable medium of claim 10 further comprising non-transitory instructions sufficient for encoding the media component when formatted as a video comprised of a plurality of video frames such that each of the plurality of segments within the first and second representations include an equal quantity of the plurality of video frames.

12. The non-transitory computer-readable medium of claim 11 further comprising non-transitory instructions sufficient for selecting the first value to correspond with a first resolution and the second value to correspond with a second resolution such that each of the plurality of video frames within the first representation are encoded at the first resolution and each of the plurality of video frames within the second representation are encoded at the second resolution, the first and second resolutions differing sufficiently such that the bit rates for matching video frames included within both of the first and second representation proportionally differ.

13. The non-transitory computer-readable medium of claim 11 further comprising non-transitory instructions sufficient for selecting the first value to correspond with a first quantization parameter and the second value to correspond with a second quantization parameter such that each of the plurality of video frames within the first representation are encoded using the first quantization parameter and each of the plurality of video frames within the second representation are encoded using the second quantization parameter, the first and second quantization parameters differing sufficiently such that the bit rates for matching video frames included within both of the first and second representation proportionally differ.

14. The non-transitory computer-readable medium of claim 10 further comprising non-transitory instructions sufficient for encoding the media component when formatted as a video comprised of a plurality of video frames such that the first value has a greater temporal resolution than the second value resulting in each segment of the first representation including more of the plurality of video frames than the matching segment of the second representation.

15. The non-transitory computer-readable medium of claim 9 further comprising non-transitory instructions sufficient for generating metadata suitable for transmission to a client desiring access to the media component, including individually identifying a bandwidth attribute within the metadata for each of the segments included within both of the first and second representations such that a quantity of bandwidth attributes included within the metadata for the first and second representations at least equals a quantity of segments totaling the first and second representations, each bandwidth attribute being sufficient for representing to the client the bit rate associated with encoding of the corresponding segment.

16. The non-transitory computer-readable medium of claim 9 further comprising non-transitory instructions sufficient for generating metadata suitable for transmission to a client desiring access to the media component, including representing a perceived quality relationship within the metadata sufficient for relating the first and second values to a display size and a viewing distance in a manner sufficient to enable the client to differentiate the first and second representations as a function of a display size and a viewing distance associated with a user thereof.

17. A non-transitory computer-readable medium having a plurality of non-transitory instructions, which when executed with a processor of a media device, are sufficient for adaptively facilitating access to a media component, the non-transitory instructions being sufficient for:
determining a capability of a user of the media device to perceive the media component at a first instance in time;
determining a bandwidth available to the media device at the first instance to facilitate streaming the media component over a network from a remotely located media server;
determining at least a first representation and a second representation of the media component to be available from the media server for streaming over the network to the media device, the first representation having a first quality greater than a second quality of the second representation;
determining the bandwidth as being sufficient to enable streaming of the first and second representations to the media device; and
requesting the media server to stream one of the first and second representations to the media device depending on the capability, including requesting:
i) the first representation when the capability exceeds a threshold; and
ii) the second representation when the capability fails to exceed the threshold.

18. The non-transitory computer-readable medium of claim 16 further comprising non-transitory instructions sufficient for determining the capability as a function of a display size and a viewing distance, the display size representing a viewable dimension for a display of the media device used to interface the media component with the user and the viewing distance representing a length between the user and the display.

19. The non-transitory computer-readable medium of claim 16 further comprising non-transitory instructions sufficient for determining the capability as a function of an interface size or range and an interface distance, the interface size or range representing an audio or video capability of an output of the media device used to interface the media component with the user and the interface distance representing a length between the user and the output.

20. The non-transitory computer-readable medium of claim 16 further comprising non-transitory instructions sufficient for:
determining the first and second representations to each include a plurality of segments, including each segment in the first representation matching with one segment in the second representation and substantially all of the plurality of segments having an approximately equal duration; and
determining the bandwidth as being sufficient to enable streaming of the first and second representations based at least in part on processing a plurality of bandwidth attributes received from the media server at a second instance in time occurring prior to the first instance, each bandwidth attribute being associated with one of the plurality of segments and sufficient to represent network capacity associated with the streaming thereof.
